(19) United States
(12) Patent Application Publication
(10) Pub. No.: US 2014/0190445 A1
(43) Pub. Date: Jul. 10, 2014

(54) CONTROL HOUSING MODULE AND PRODUCTION METHOD

(71) Applicants: Eckhard Reese, Aspensen (DE); Guenther Zoll, Stuttgart (DE)

(72) Inventors: Eckhard Reese, Aspensen (DE); Guenther Zoll, Stuttgart (DE)

(73) Assignee: DAIMLER AG, Stuttgart (DE)

(21) Appl. No.: 14/237,957

(22) PCT Filed: Jul. 17, 2012
(86) PCT No.: PCT/EP2012/002997

§ 371 Date: Feb. 10, 2014

(30) Foreign Application Priority Data
Aug. 24, 2011 (DE) 10 2011 111 744.3

(51) Int. Cl. F02F 7/00

(52) U.S. Cl. CPC F02F 7/0073
USPC 123/198 E; 29/527.1

(57) ABSTRACT

A control housing module (1) for a combustion engine, with integrating and/or connecting and/or receiving structures for auxiliary components (2,3,4,5,6,7,8) and a rib structure. The control housing module (1) consists of a fibre-plastic composite, which has at least one insert (10) made from a flat fibre textile in a thermoplastic matrix. The rib structure made from injected reinforcing ribs (11,11a) is formed of a thermoplastic, which has short fibres made of a reinforcing material with a proportion by volume of at least 30%. The ribbing (11,11a) includes rib structures (11a) arranged according to the direction of force and regularly formed longitudinal, transverse and/or diagonal reinforcing ribs (11) that cross one another. A foam material is arranged in the spaces (13) between the ribs, the spaces being bordered by the ribs (11,11a).

The invention relates to a control housing module for a combustion engine, in particular for a combustion engine of a motor vehicle and a method to produce the control housing module.

Until now, control housing modules for combustion engines have been produced in batch production almost exclusively from Al—Si alloys by die casting, as is described, for example, in DE 44 00 952 C1. In difficult embodiments, grey cast iron can also be used to manufacture the control housing module corresponding to the crankcase. Furthermore, an Mg alloy is also possible in die casting, which is often used in racing engines.

The present invention relates to a control housing module for a combustion engine, said control housing module being fixed to a front side of the combustion engines and on which auxiliary components such as for example a water pump, an oil filter, a thermostat, a three-phase generator, a power steering pump, coolant compressors, a belt tensioner as well as deflection rollers. Advantageously, the control housing module allows as many auxiliary components, which are partially dependent on one another, as possible to be arranged optimally with respect to one another. Therein the housing cover can be implemented with a cavity divided into chambers, in which the respective components such as an oil pump, coolant pump or thermostat valve can be received. Therein the chambers are connected to one another via flow channels. Furthermore, receiving structures for the other auxiliary components are provided outside the cavity.

A plurality of possible embodiments of a control housing module is known from DE 196 12 360 C1, DE 196 35 534 A1, EP 0 843 081 A1, DE 196 47 299 C1, DE 196 35 534 C2 and DE 10 2005 025 882 A1, without naming materials.

Thus, EP 0 843 081 A1 describes, for example, a control housing cover with an optimised oil circuit or an improved integration of the oil pump into the oil circuit in order to avoid external controlling of the oil pump. Therein the housing cover has channels on the pure oil side behind the oil filter, which lead to a cylinder block, wherein the supply line on the pure oil side of the oil filter is led back to the same cylinder block to control the oil pump.

Furthermore, DD 211 146 A1 discloses an embodiment of a control housing cover with ribbing to reduce noise emissions.

A module to drive a cam shaft is known from EP 1522682 A1, which has a housing made from fibre-reinforced plastic. DE 3606052 A1 discloses housing parts for motor vehicle drive groups made from plastic moulding compounds. The parts are created from plastic moulding compounds by injection moulding or pressing and are reinforced with a prefabricated reinforcement.

Based on this prior art, the object of the present invention is to create a control housing module with a plurality of partially integrated receiving, connecting structures for auxiliary components, said control housing module also having further potential for weight saving with respect to the control housing cover made from light metal and contributing to cost reduction.

This object is solved by a control housing module having the features of claim 1 and with a method having the features of claim 8. Developments are embodied in the sub-claims.

A first embodiment relates to a control housing module for a combustion engine. The control housing module has integrating and/or connecting and/or receiving structures for the auxiliary components as well as a rib structure. Auxiliary components, which are to be fixed to the control housing module or which exist at least partially integrated therein, can be a radial shaft seal for a crankshaft, a water pump, a coolant compressor, a generator, an oil filter, a duct for coolant and/or an oil sump connection. The control housing module according to the invention consists of a fibre-plastic composite, which has at least one impregnated and consolidated insert made from a flat fibre textile in a thermoplastic matrix. The rib structure consists of reinforcing ribs, which are injected into the insert and are made from a thermoplastic. The thermoplastic of the reinforcing ribs comprises short fibres made from a reinforcing material having a proportion by volume of at least 30%. The fibre content decreases the tendency of the injected reinforcing ribs of the control housing module to creep and thus improves the dimensional stability thereof, even at an increased temperature.

Thus the fibre-reinforced plastic control housing module for a combustion engine, which uses the fibre-plastic composite construction method and has the thermoplastic ribs that contain a high proportion of short fibres, provides a cost-efficient control housing module with a further reduced weight, which is thus suitable for the growing demands regarding fuel consumption and exhaust gas emissions in the automobile industry.

In one embodiment of the control housing module, a fibre volume content of 30% can be sufficient; the proportion by volume of the short fibres can, however, also amount to 40% or more in further embodiments, for example 50% or 60% or even more, for example up to 90%, as long as it is ensured that the fibre containing thermoplastic is able to be injected.

Due to its use in the vicinity of a combustion engine, suitable thermoplastic materials for the matrix and/or the ribs have a high level of thermal resistance, such as for example a polyamide, polyphenylene sulphide, polyphthalamide, polyetheretherketone and combinations thereof. Furthermore, polysulphone, polyetherimide and polytetrafluoroethylene are suitable thermoplastics for use at high temperatures.

The ribbing that strengthens the control housing module can not only comprise rib structures orientated in the direction of force but also regularly formed longitudinal, transverse and/or diagonal reinforcing ribs, which can even cross one another. To improve sound and/or heat insulation, the spaces between the ribs that are bordered by the ribs can be filled with a foam material, in particular made from polyamide or polyurethane.

The control housing module can be provided with a flat reinforcing structure at least in sections on the side of the ribs that are facing away from the insert and alternatively or additionally on the side of the insert that is facing away from the ribs. This additional reinforcing structure can be useful above all in regions of increased application of force such as the connecting regions for the coolant compressor and the generator on the control housing module; however a complete covering of the ribbing structure with the flat reinforcing structure is also conceivable.

The flat reinforcing structure can be a fibre-reinforced thermoplastic sheet cut to size in accordance with the direction of force, such as an organic sheet. Planar continuous fibre-reinforced thermoplastic semi-finished products are understood by “organic sheets”, which can be thermoformed, enable short process cycles and can furthermore be easily welded. Organic sheets can thus consist of specific fibre arrangements embedded in the thermoplastic matrix, said fibre arrangements having fibres in defined positions. Thus, the fibre arrangements can be woven fabrics, non-woven fabrics, knitted fabrics etc.

Furthermore, as an alternative to the organic sheet, or in combination therewith, a flat reinforcing structure can also be made from TFP textile that is pre-impregnated and pre-consolidated with a thermoplastic and manufactured in accordance with a direction of force. Textile inserts that are not blended with the desired fibres that are orientated in the direction of force can be produced by means of the “tailored fiber placements”. A further alternative consists in an arrangement of prepreg-tape that is set corresponding to the direction of force and that are made from reinforcing fibres in a thermoplastic matrix, wherein this flat reinforcing structure made from the prepreg-tape firstly results directly on the insert.

The flat reinforcing structure can be connected directly to the ribs and/or to the insert by means of the included thermoplastic; however, an additional thermoplastic layer can also be provided as a connecting layer.

The thermoplastic of the thermoplastic sheet, of the pre-impregnated TFP textiles, of the prepreg-tape and/or of the layer (12′) can likewise be a thermally resistant thermoplastic such as polyamide, polyphenylene sulphide, polyphthalamide, polyetheretherketone and combinations thereof, corresponding to the insert and to the ribs. The thermoplastic of a connection layer can likewise comprise short fibres made from a reinforcing material in a proportion by volume of at least 30%, corresponding to the ribs.

In one embodiment, the control housing module can be composed virtually from two-part components, of which each has an insert in a thermoplastic matrix having the injected rib structure.

These two part components are connected, for example welded, to each other via the rib structures.

Also one embodiment of the control housing module requires the use of at least two inserts, in which embodiment a first insert is provided a moulded section of a semi profile, which makes up a cavity profile with a second insert, which is therefore connected to the first insert.

Thus, the control housing module can also have at least one fibre-reinforced plastic pipe as a duct which is integrated into the insert. Likewise, a fibre-reinforced plastic pipe which is integrated into the insert can be used to reinforce the edges thereof.

The impregnated and consolidated insert made from a flat fibre textile in a thermoplastic matrix is preferably an organic sheet, wherein the flat fibre textile is a woven fabric or a non-woven fabric, in particular satin, twill or linen weave, made from reinforcing fibres, which are glass, carbon and/or polymer fibres, in particular aramid fibres.

To produce the control housing module, firstly a flat fibre textile in a thermoplastic plastic matrix is cut to size corresponding to the control housing module with regard to the impregnated and consolidated insert. This is heated at least to ductility and inserted into an injection mould. If necessary, the insert can already be preformed before insertion into the injection mould. Then, in the injection mould, the insert acquires its final shape after the mould halves are closed. Then, at least the provided ribbing made from the thermoplastic, which comprises short fibres made from a reinforcing material in a proportion by volume of 30%, is injected there. A particularly good connection of the ribbing, particularly a positive connection to the basic body of the component formed by the insert, is known from the use of thermoplastic materials for matrix and ribbing with similar or corresponding properties (e.g. melting temperature), in particular from the use of the same thermoplastic materials for matrices and ribbing. This can be supported if the matrix of the insert is at least melted on the surface in the mould. After the setting of the ribs, the control housing module can be removed from the injection mould.

Further embodiments of the method according to the invention comprise at least one of the following steps:

Integrating and/or connection and/or receiving structures are formed during cutting, moulding and/or injecting, wherein the manufacturing of the undercuts can be comprised by means of an injection mould of several parts.

Furthermore, the filling of the spaces between the ribs with foam, for example with PA or PUR, can occur directly after the formation of the ribs, even in the same injection mould.

The arranging and connecting of a flat reinforcing structure on the side of the ribs that faces away from the insert and/or the side of the insert that faces away from the ribs, for example by welding by means of a thermoplastic layer, takes place after the end of the injection moulding cycle, for example after the de-moulding of the component. If the flat reinforcing structure is provided on the side of the insert facing away from the ribs, then the arrangement of the same can also take place before the injection moulding.

Furthermore, the production of the component can comprise the connection of at least two inserts, equipped with an injected rib structure, by welding onto the ribs.

The formation of an integrated cavity profile in the component can occur before the injection moulding cycle by the connection at least two inserts. Alternatively or additionally, a fibre-reinforced plastic pipe can be integrated into the insert as a duct. A fibre-reinforced plastic pipe can furthermore be used to reinforce the edges. For this purpose, the fibre-reinforced plastic pipe is wrapped with the textile insert at the edge.

These and other advantages are demonstrated by the description below with reference to the accompanying figures.

The reference to the figures in the description serves to support the description and to facilitate understanding of the subject matter. The figures are only a schematic depiction of an embodiment of the invention. Here are shown:

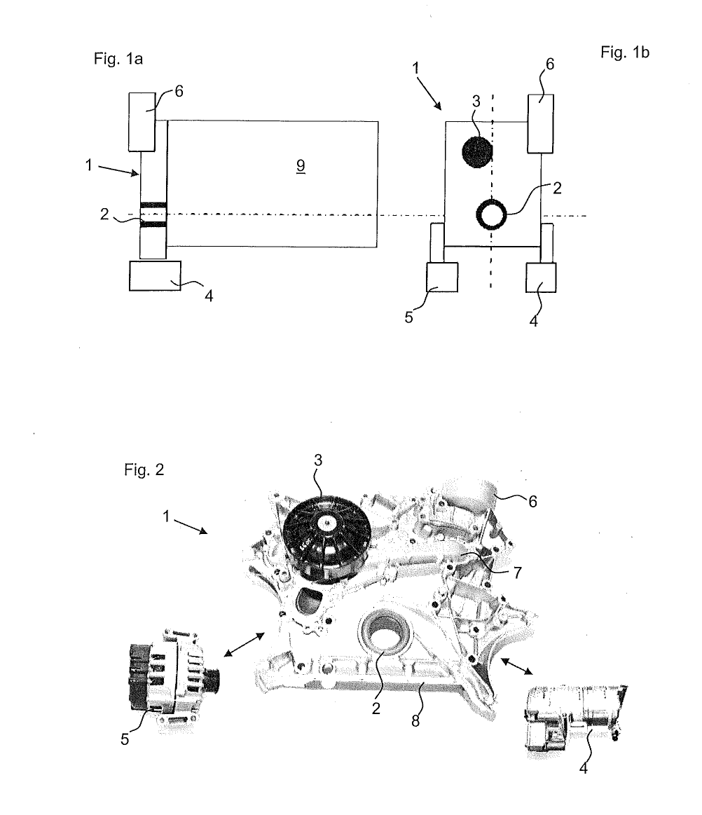

FIG. 1 a schematic side and front view of a control housing module, which is arranged on the front side of a combustion engine,

FIG. 2 a perspective depiction of a control housing module made from Al-Si die casting having connecting elements,

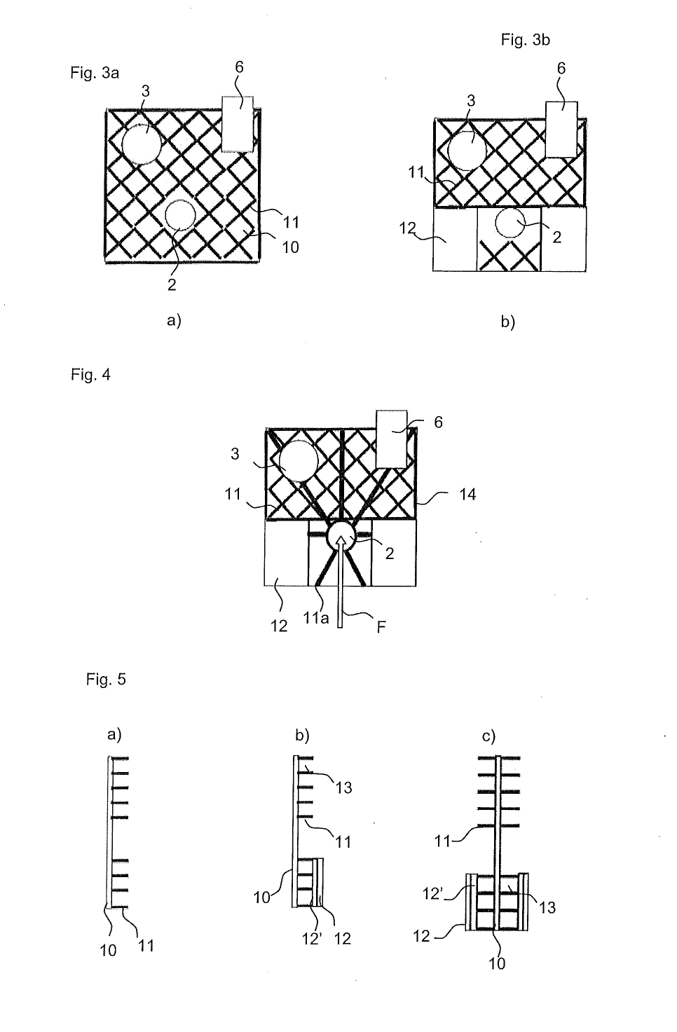

FIG. 3a, b schematic front views of two control housing modules implemented according to the invention,

FIG. 4 a schematic front view of a further control housing module implemented according to the invention,

FIG. 5 a, b, c side sectional views of three control housing modules implemented according to the invention,

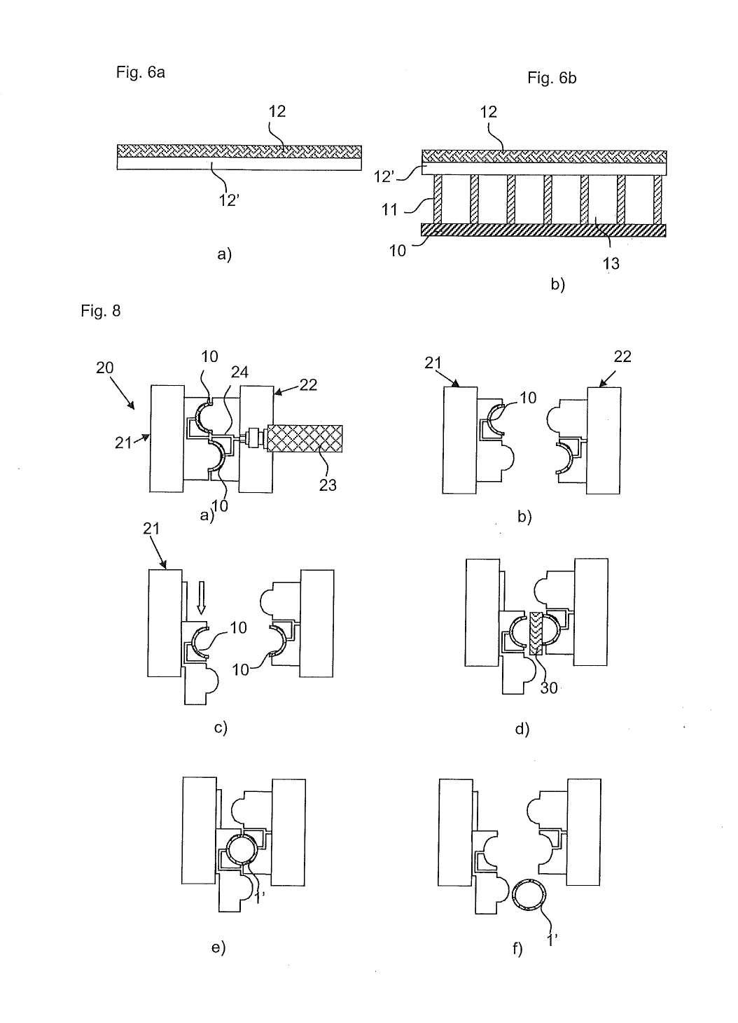

FIG. 6a, b a side sectional view through a modified fibre-reinforced thermoplastic sheet and a side sectional view through a section of a control housing module having additional reinforcement by a welded fibre-reinforced thermoplastic sheet,

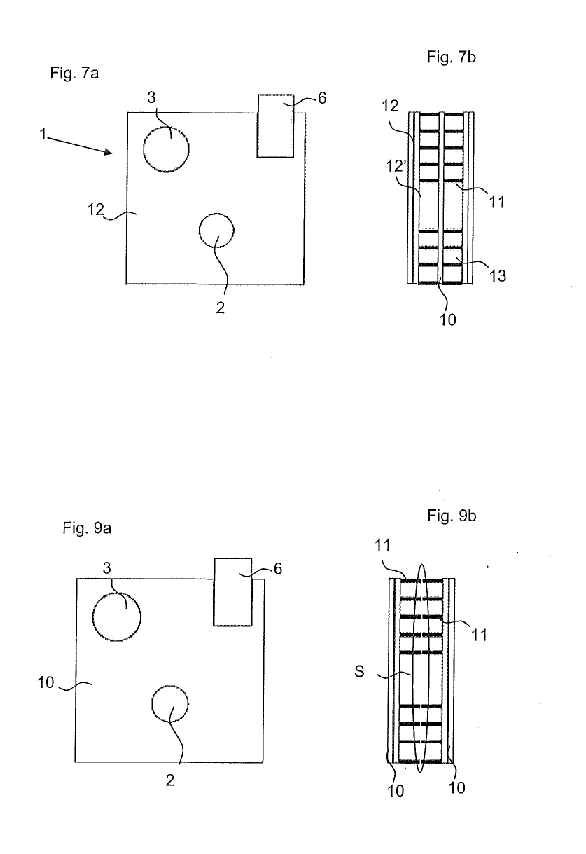

FIG. 7 a schematic front and side sectional view of a further control housing module implemented according to the invention,

FIG. 8 process steps a) to f) for the welding of two half shells directly in the injection mould (“ENGEL joinmelt”)

FIG. 9a, b a schematic front and side sectional view of a further control housing module implemented according to the invention, made from two half modules that are welded together, according to the process from FIG. 8,

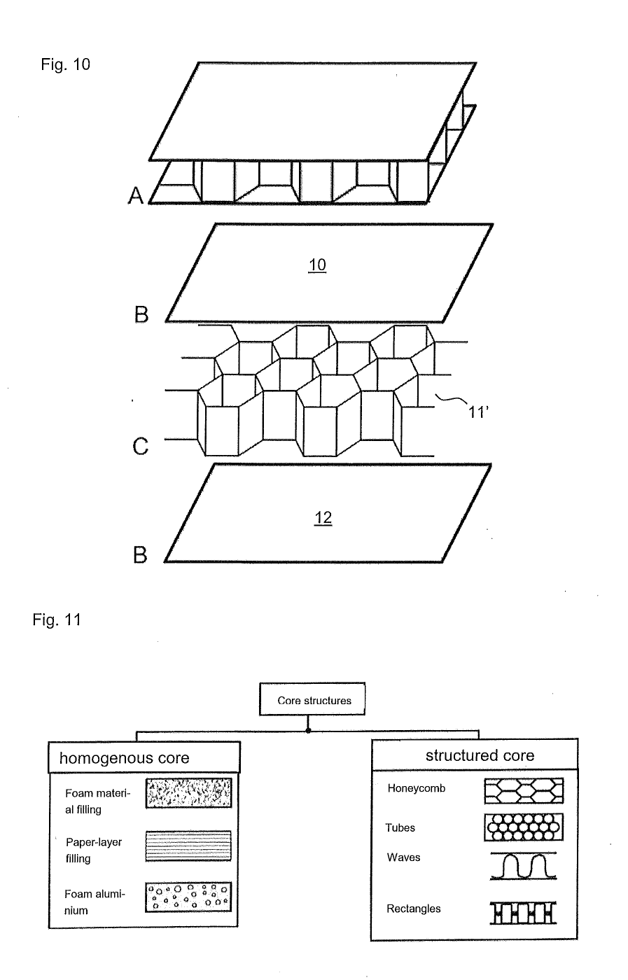

FIG. 10 a sandwich construction (A) in a perspective view, consisting of a textile insert, a structural core and a fibre-reinforced thermoplastic sheet (B),

FIG. 11 possible embodiments of the structural core from FIG. 10,

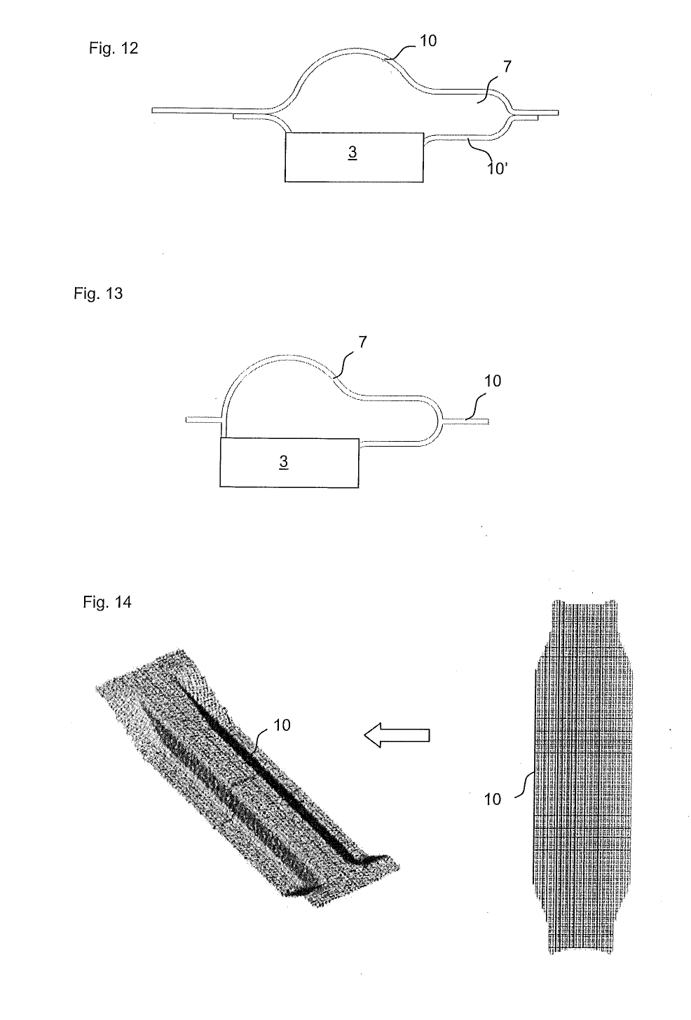

FIG. 12 a schematic side sectional view through a section of the control housing module having a partially integrated water pump and a corresponding coolant pipe,

FIG. 13 a schematic side sectional view through a section of the control housing module having a coolant pipe of the water pump which is completely or partially integrated into the structure as a fibre-reinforced pipe,

FIG. 14 an example of an unwound organic sheet insert,

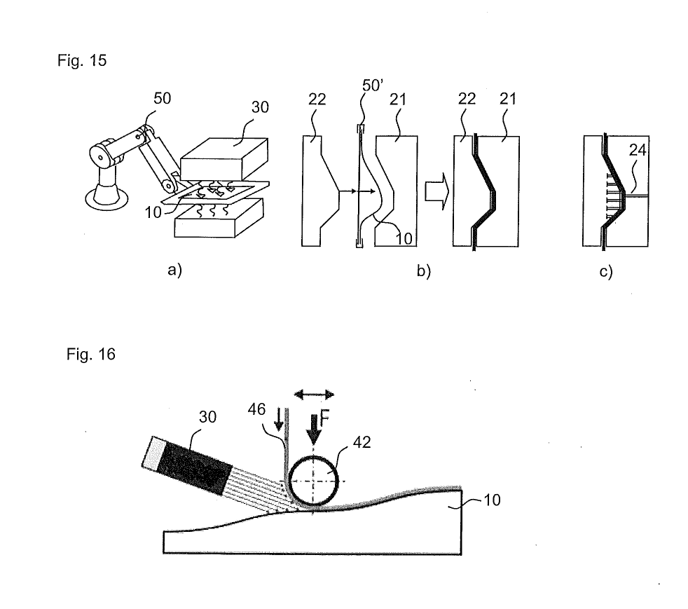

FIG. 15a, b, c a principal method procedure for the back injection of an organic sheet insert,

FIG. 16 a principle schematic diagram of the tape-laying

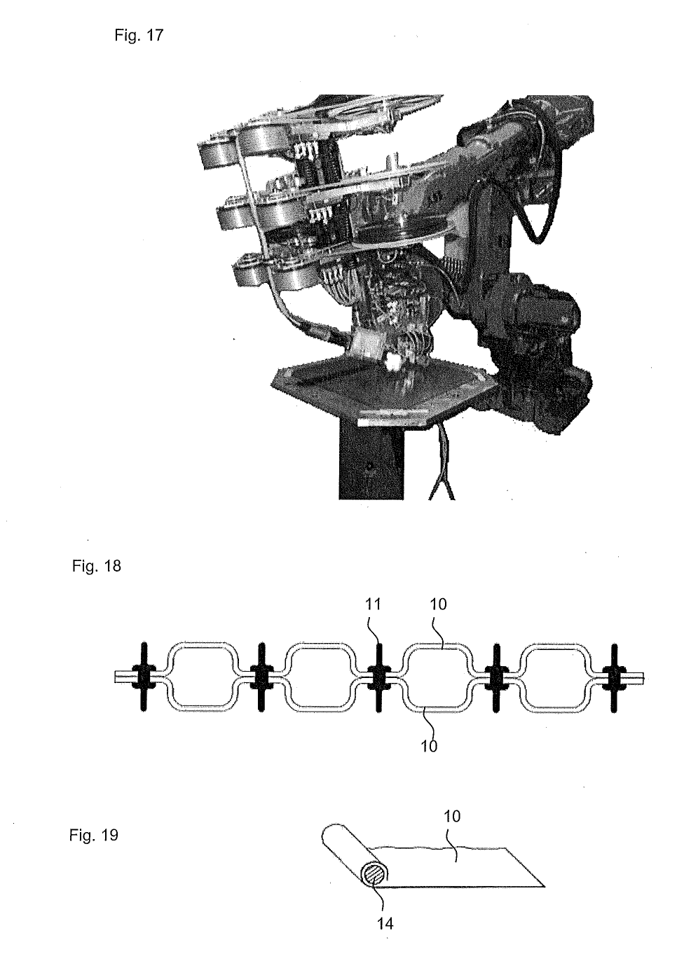

FIG. 17 an example of a multi tape-laying head,

FIG. 18 a sectional view through a closed case profile injected with ribs, made from two organic sheets provided with swages,

FIG. 19 a perspective sketch of reinforcing at the edge of an organic sheet insert by means of wrapping a fibre-reinforced cavity profile,

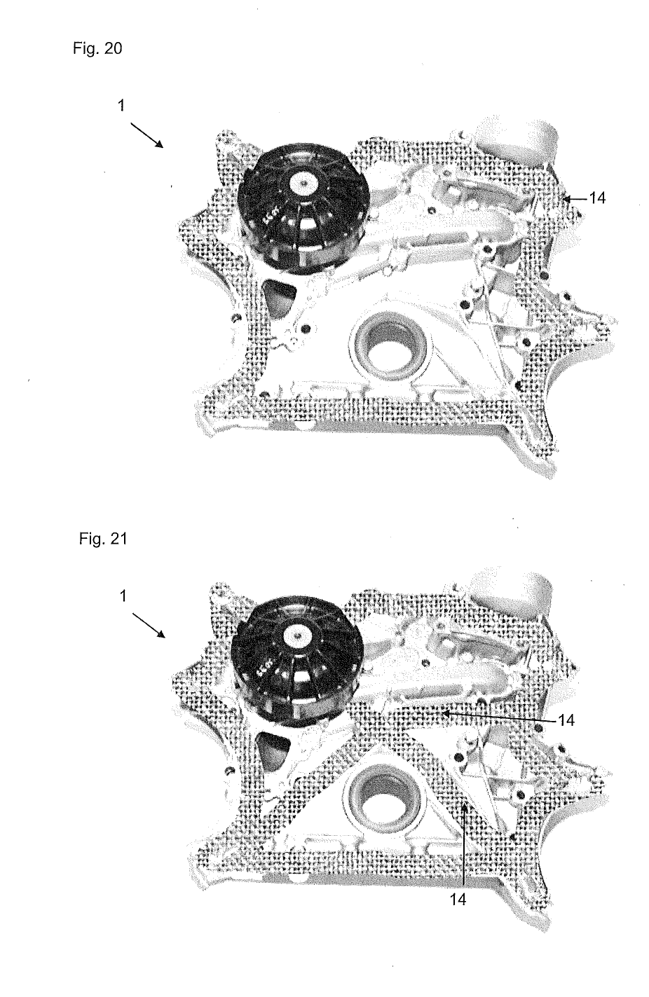

FIG. 20 a perspective view of a control housing module implemented according to the invention,

FIG. 21 a perspective view of a further control housing module implemented according to the invention.

The device according to the invention relates to a fibre-reinforced plastic control housing module in a fibre-plastic composite structure based on a thermoplastic matrix that contains a high proportion of short fibres. Suitable fibre materials comprise glass, carbon and polymer fibres, in particular aramid. Combinations of the fibre materials can also be used. Further fibre materials, which can be used at least proportionately, comprise metal fibres, natural fibres, ceramic fibres, basalt fibres, etc.

As is depicted in principle on the left in FIG. 1, the fibre-reinforced control housing module 1 is fixed to a front side of a combustion engine 9. Therein auxiliary components, such as, for example, a water pump 3, oil filter 6, thermostat, three-phase generator 5, power steering pump, coolant compressor 4, belt tensioner as well as deflection rollers, are fixed to or can be partially integrated into the control housing module 1, as is also shown in FIG. 2. There it can also be seen that some components can exist at least partially integrated, such as the oil filter 6 and a duct 7 for a water pump. Furthermore, a radial shaft seal 2 for the crank shaft can be seen, and the connecting structure 8 for the connection to the oil sump. Other auxiliary components such as the coolant compressor 4 and the generator 5 are fixed to corresponding connecting structures.

FIG. 2 shows therein a control housing module 1, produced by die casting, from an Al-Si alloy according to prior art.

Due to growing demands regarding fuel consumption and the exhaust gas emissions in the automobile industry, the fibre-reinforced plastic control housing module 1 according to the invention having the corresponding connecting structures for the integrated auxiliary components enables a cost and weight reduction and thus the possibility to implement a consequently lightweight construction in the motor area by the substitution of the metal components with a fibre-plastic composite.

A control housing module 1 according to the invention, as can be seen in the principle schematic diagram of FIG. 3, consists fundamentally of an organic sheet insert 10, which is injected with ribs 11 in an injection moulding machine with a thermoplastic (e.g. polyamide, polyphenylene sulphide/polyphthalamide, polyetheretherketone, etc.) that contains a large proportion of short fibres (e.g. 30%, 40%, 60% fibre proportion by volume) and thus obtains its definitive geometry. Therein, preferable thermoplastics have a high thermal resistance and a good dimensional stability as well as advantageously high strength values. Possible undercuts, such as for example in the connection of the oil filter 6, of the connection of the water pump 3 or of a receiver 2 for the radial shaft seal can be implemented with the help of injection moulds of several parts.

Organic sheets 12 are textile surface semi-finished products (e.g. woven fabric, non-woven fabric made from reinforcing fibres, for example glass, carbon and/or aramid fibres), which are pre-impregnated and consolidated with a thermoplastic. Netted and knitted fabrics etc. are also possible as further fibre textiles, and further fibre materials, which can be used alternatively or in combination, are metal fibres such as steel fibres or also ceramic fibres, natural fibres, basalt fibres or polymer fibres. The fibres of the fibre textiles can only be orientated in one direction, or can be orientated in two directions at any angle to one another, for example at a right angle to one another.

In FIG. 3a), a control housing module 1 according to the invention can be seen, which is only reinforced with the ribs 11, while on the right in FIG. 3b) additional local reinforcements are provided by welded fibre-reinforced thermoplastic sheets 12 which can likewise be organic sheets. In FIG. 5, the corresponding cuts of this are depicted in a) and b), which lie longitudinally through the control housing module 1. The fibre-reinforced thermoplastic sheets 12 are connected to the rib structures 11 by means of a connecting or welded layer 12′.

As FIG. 4 shows, the ribbing of the insert 10 can occur on two different levels. A topologically optimised structure 11 a occurs according to the main direction of force as a primary, irregularly-formed reinforcement. This structure 11 a serves to receive the main load, indicated by the example load F. The secondary, regularly formed rib structure 11 for reinforcement serves primarily to strengthen the control housing module 1 against flexural and torsional loading, together with the framework 14. The structure can additionally be strengthened by the insertion of swages into the geometry of the insert. The ribbing can additionally lead to a noise reduction through a skilled design.

Furthermore, the space 13 between the ribs 11 can additionally be filled by a plastic foam, for example made from a polyamide or a polyurethane subsequent to or during the actual injection moulding process (e.g. in the 2K injection moulding of compatible thermoplastics), cf. FIG. 5b. This can effect additional sound insulation, depending on the pore content, the pore density and the pore geometry. Therein, open cell foams are particularly well suited for sound insulation, and closed cell foams on the other hand for thermal insulation. If necessary, the ribbing 11 can also occur on both sides of the insert 10. This case is outlined in FIG. 5c), wherein additionally the strengthened sandwich formation is depicted with further organic sheets 12. Here the spaces 13 between the ribs can also be filled with foam.

The sandwich formation with the welded organic sheets 12 can therein occur on particularly loaded positions such as, for example, the connection of the generator 5 and the coolant compressor 4, cf. FIG. 2. There, the organic sheets 12 can be locally welded onto the rib structures 11 (e.g. by infra-red or hot gas welding), such that the organic sheets 12 form a strengthened sandwich structure together with the ribbing 11 and the insert 10.

The organic sheets 12 can be made to be able to be welded, in that, for example as is depicted in FIG. 6a), they are connected on one side to an extruded thermoplastic film 12′ in the production process by hot rolling. This thermoplastic film 12′ can consist, like the thermoplastic matrix of the organic sheet 12, for example, of polyamide, polyphenylene sulphide/polyphthalamide, polyetheretherketone, but further thermoplastics are also conceivable. The thermoplastic matrix of the organic sheet 12, the thermoplastic film 12′ and the injected rib structure 11 can comprise the same thermoplastic, but they can also be different plastics. Like the thermoplastic material of the ribs 11, the thermoplastic film 12′ can also contain a high proportion of short fibres (e.g. with a fibre proportion by volume of 30%, 40% or 60%).

The control housing module 1 can furthermore be manufactured as a complete sandwich construction and thus as a case profile having the organic sheets 12 as “covers”. FIG. 7 shows a top view and a longitudinal view of this. The organic sheet insert 10 is injected with ribs 11 on both sides, onto which the organic sheets 12 are injected with the thermoplastic film 12′ respectively. Here the space 13 between the ribs 11 can also be filled with foam.

A further production method is depicted in FIG. 8 a) to f) and consists in two inserts 10 being injected with ribs simultaneously in a mould 20 by means of a gating system 23, 24 (a), pulling apart the mould halves 21, 22 (b), such that a respective insert 10 remains in a mould shell of each mould half 21, 22, and lowering a mould half 21, such that both inserts 10 lie opposite each other (c). After a cooling phase for setting, these two inserts 10 are heated on the contact surfaces of the ribs by means of a heating device 30 in the same mould 20 (d), for example by means of infra-red of hot gas and welded to each other (e) by putting the mould halves 21, 22 together. After this, the produced component 1′, which is a pipe profile in FIG. 8, can be removed from the mould. The method for hot gas welding directly in the injection mould outlined in FIG. 8 was developed by the companies Engel, Hummel-Formen and KVT Bielefeld and is known by the name “ENGEL joinmelt”.

A control housing module 1 produced in this way is depicted in FIG. 9. The rib structures 11 are injected on one side on two organic sheet inserts 10, and both halves are welded to one another on the contact surfaces of the ribs 11 (indicated region S).

Generally, a structural core 11 could also be inserted between the insert 10 and the outer organic sheet 12 in place of the rib structure 11 as a spacer for the sandwich structure (FIG. 10). Possible embodiments for a structural core 11 are depicted in FIG. 11.

The insert 10 can be moulded by a moulding process corresponding to a half of the component to be integrated for a partial integration of auxiliary components (e.g. water pump 3), wherein the second half 10′ is fixed to the control housing module (FIG. 12). An integrated coolant pipe 7 is created by the connection of the moulded section of the insert 10 and the second half 10′ which allows the partial integration of the water pump 3. In the case of an integration of the water pump 3, as is outlined in FIG. 13, the necessary coolant pipe 7 can be completely or partially integrated into the insert structure 10 that is injected with ribs by a fibre-reinforced plastic pipe 7. Therein, the fibre-reinforced plastic pipe 7 can be consolidated and injected with ribs either in a preceding step or directly in the injection mould.

Fibre-reinforced plastic pipe half moulds used for this can be produced continuously in the weaving process. The moulding and consolidating can alternatively occur via the projectile injection technology (PIT), the water or gas injection technology (WIT/GIT), the core melting method or also the blow moulding method. Further method variants are pultrusion weaving or laser-supported thermoplastic winding.

The insert 10 made from a flat fibre-reinforced thermoplastic is preferably an organic sheet insert 10 made from, for example, glass, carbon or aramid fibre fabric using, for example, satin, twill or linen weave and consolidated in a thermoplastic matrix (e.g. PA PPS/PPA, PEEK). Herein the insert 10 is firstly cut to size (finishing) (on the right of FIG. 14). The strong organic sheet cutting 10 is then pre-moulded when heated, for example, by means of infra-red (the control housing module is not depicted on the left of FIG. 14, however, but only a moulded organic sheet cutting as an example). The heating of the organic sheet 10 is depicted in FIG. 15 in the first station a). A robot 50 moves the organic sheet cutting 10 to the heating device 30 and then, after the thermo-plastic matrix plastic is softened or made fluid, the organic sheet cutting 10 can be moulded, if necessary already by means of suitable grippers 50′, before this is inserted into the injection mould 21, 22 and completely moulded there by closing the mould 21, 22 (FIG. 15b). Finally, the completely moulded semi-finished product is injected with ribs (c) by the gating system of the mould, with which the component is given its definitive geometry.

Additionally cover layers that are cut to size corresponding to the direction of force (not shown in the figures), likewise made from an organic sheet or from a pre-impregnated and pre-consolidated TFP textile, can be welded onto the organic sheet insert (e.g. via infra-red or hot gas welding), at heavily-loaded local positions of the control housing module 1, such as for example on the connecting positions of the generator 5 and coolant compressor 4 (cf. FIGS. 1 to 4). A TFP insert (“tailored fiber placement”) is produced with fibre strands that are fundamentally aligned in the direction of force and are set on a base layer, said fibre strands being attached with fixing strands in order to form the TFP textile with almost any material thickness.

This can either occur before or after the injection moulding process, wherein after the injection moulding process, the additional reinforced cover layer structures can be attached exclusively to the sides facing away from the rib structure.

Furthermore, it is likewise possible that the prepreg tapes (so-called tapes) consisting of fibre-rovings, which comprise glass, carbon and/or aramid fibres, which are pre-impregnated with a thermoplastic matrix (e.g. PA, PPS/PPA, PEEK), are laid on the organic sheet insert 10 in accordance with the direction of force before or also after the injection moulding process, in the so-called tape-laying process, as a reinforcing structure. FIG. 16 shows how a prepreg tape or tape 46 is removed from a coil, is heated to a process temperature, for example by the shown laser 30, and is welded directly to the mould 10 by a pressure roller 42. The matrix material of the prepreg tape 46 is melted by the concentrated application of heat and the fibres are embedded into the matrix by the applied pressure and thus are connected to the organic sheet insert 10. The method can additionally be fundamentally accelerated by the use of several tape-laying heads, for example with a multi tape-laying head shown in FIG. 17.

In order to reach a high flexural and torsional rigidity, the control housing module 1 can also be implemented as a closed case profile, in which two half shells 10 (cf. FIG. 18) that are not necessarily symmetrical and are provided with swages and are made from organic sheets, are injected with the rib structure 11 made from thermoplastic (e.g. PA 6.6, PPS/PPA, PA 4.6, PEEK) that contains a high proportion of short fibres (e.g. 30%, 40%, 60% fibre proportion by volume), and therein simultaneously joined to holes inserted into the shells 10. The two half shells 10 are moulded to the definitive geometry before the injection moulding process.

In order to stabilise the free edges of the insert 10, wrapped or injected fibre-reinforced plastic pipes 14 having hollow cross-sections can be used to strengthen the edges, as is depicted in FIG. 19. One embodiment for an exemplary control housing module 1 is depicted in FIG. 20. There, strengthening of the edges is provided by a fibre-reinforced plastic pipe 14. Additionally, such pipes 14 can be laid transversely through the control housing module 1 to receive the main loads, as is indicated in FIG. 21.

The strengthening behaviour of the occurring use can be adapted by the back injection of the insert. The possibility is created to form closed profile cross-sections. The back-injected insert offers further potential to save weight with regard to the light metal control housing modules, such that a further reduction of the fuel consumption and thus the exhaust gas emissions is enabled. Additionally, the fibre-reinforced plastic control housing module is more cost-efficient with regard to the light metal control housing modules and can be produced with high production accuracy and also without post-processing. Furthermore, a material damping as well as a high degree of functional integration (e.g. integrated threads) and the possibility of health monitoring by sensor integration are provided.

In the embodiment as a sandwich with the organic sheet arranged additionally on the ribs, further possibilities result to reduce the noise emission and/or the thermal insulation as well as an increase of the component rigidity.

Furthermore, load-optimised structures are created by the welding of the prepreg tapes/tapes.

The use of an organic sheet as an insert spares the separate step of impregnating and consolidating a textile insert. As preferably a thermoplastic is used for the thermoplastic matrix of the organic sheets and the injected ribs (as well as further welded elements such as the flat reinforcing structures or the prepreg tapes), which have at least similar, preferably the same melting properties and is able to be mixed, further bonding agents can be dispensed with. Particularly advantageously, the used thermoplastics can be the same.

1. A control housing module (1) for a combustion engine, which comprises integrating and/or connecting and/or receiving structures for auxiliary components (2,3,4,5,6,7,8) and a rib structure, wherein the control housing module (1) comprises of a fibre-plastic composite, which has at least one insert (1) made from a flat fibre textile in a thermoplastic matrix, wherein the rib structure is made from injected reinforcing ribs (11,11a) and consists of a thermoplastic which comprises short fibres made from a strengthening material with a proportion by volume of at least 30%, wherein the ribbing (11,11a) comprises rib structures (11a) that are arranged according to the direction of force and regularly moulded longitudinal, transverse and/or diagonal reinforcing ribs (11) that cross one another, and wherein a foam material is arranged in the spaces (13) between the ribs that are bordered by the ribs (11,11a).

2. The control housing module (1) according to claim 1, wherein the proportion by volume of the short fibres amounts to at least 40%.

3. The control housing module (1) according to claim 1, wherein the thermoplastic material of the matrix and/or the ribs (11,11a) has a high level of thermal resistance.

4. The control housing module (1) according to claim 1, wherein the control housing module (1) is provided at least in sections with a flat reinforcing structure (12)
on the side of the ribs (11,11a) facing away from the insert (10) and/or
on the side of the insert (10) facing away from the ribs (11,11a) which is
a fibre-reinforced thermoplastic sheet (12) cut to size in accordance with a direction of force, and/or
a TFP textile, pre-impregnated and pre-consolidated with a thermoplastic and manufactured in accordance with a direction of force and/or
an arrangement of pre preg tapes that are laid corresponding to a direction of force made from reinforcing fibres in a thermoplastic matrix,
wherein the flat reinforcing structure (12) is connected to the ribs (11,11a) and/or to the insert directly or by means of a thermoplastic layer (12′), and
wherein the thermoplastic of the thermoplastic sheet (12), of the pre-impregnated TFP textile, of the prepreg tapes and/or of the layer (12′) consists of a thermally resistant thermoplastic from a group comprising polyamide, polyphenylene sulphide, polyphthalamide, polyetheretherketone and combinations thereof, and
wherein the thermoplastic layer (12′) comprises short fibres made from a reinforcing material in a proportion by volume of at least 30%.

5. The control housing module (1) according to claim 1, wherein the control housing module (1) comprises at least two inserts (10,10′),
which are equipped with a rib structure (11,11a) respectively and are connected to one another via the rib structures (11,11a), or
of which a first insert (10) provides at least one moulded section as a semi profile, which is connected to the second insert (10′), which makes up the semi profile to cavity profile.

6. The control housing module (1) according to claim 1, wherein the control housing module (1) comprises at least one fibre-reinforced plastic pipe (14) to reinforce the edges, and/or a pipe (7) integrated into the insert (10).

7. The control housing module (1) according to claim 1, wherein the insert (10) is an organic sheet (10), wherein the flat fibre textile is a woven or non-woven fabric, made from reinforcing fibres.

8. A method for the production of a control housing module (1) according to claim 1, comprising the steps:
cutting to size the flat fibre textile having a thermoplastic matrix corresponding to the control housing module (1) to the insert (10),
heating the thermoplastic matrix and, if necessary, heating preforms and inserting the inserts (10) into an injection mould (20),
closing the injection mould (20), thereby forming the insert (10),
injecting at least the ribbing (11,11a) with the thermoplastic, which comprises short fibres made from a reinforcing material in a proportion by volume of at least 30%,
setting the ribs (11,11a) and removing the fibre-reinforced plastic control housing module (1) from the injection mould (20), wherein
the ribbing (11,11a) forms rib structures (11a) which are arranged according to the direction of force and regularly formed longitudinal, transverse and/or diagonal reinforcing ribs (11) that cross one another,
and a foam material is inserted into the spaces (13) between the ribs which spaces that are bordered by the ribs (11,11a).

9. The method according to claim 8, wherein the method comprises at least one of the steps:
forming integrating and/or connecting and/or receiving structures for auxiliary structures during cutting, moulding and/or injection or
producing undercuts by means of an injection mould of several parts or
filling the spaces (13) between the ribs with foam or
arranging and connecting a flat reinforcing structure (12) on the side of the ribs (11,11a) that faces away from the insert (10), and/or on the side of the insert (10) that faces away from the ribs or
connecting at least two inserts (10,10′) equipped with a rib structure (11, 11a) onto the ribs (11,11a) by welding
connecting at least two inserts (10,10′), forming a cavity profile or
integrating a fibre-reinforced plastic pipe into the insert (10) to reinforce the edges and/or as a pipe (7).

10. The control housing module (1) according to claim 1, wherein the proportion by volume of the short fibres amounts to at least 50%.

11. The control housing module (1) according to claim 1, wherein the proportion by volume of the short fibres amounts to at least 60%.

12. The control housing module (1) according to claim 1, wherein the thermoplastic material of the matrix and/or the ribs (11,11a) is selected from a group consisting of polyamide, polyphenylene sulphide, polyphthalamide, polyetheretherketone and combinations thereof.

13. The control housing module (1) according to claim 4, wherein the fibre-reinforced thermoplastic sheet (12) is an organic sheet.

14. The control housing module (1) according to claim 7, the flat fibre textile is a woven or non-woven fabric using satin, twill or linen weave made from reinforcing fibres which are glass, carbon and/or polymer fibres

15. The control housing module (1) according to claim 14, wherein the reinforcing fibres are aramid fibres.
